(19) United States
(12) Patent Application Publication
(10) Pub. No.: US 2009/0322477 A1
(43) Pub. Date: Dec. 31, 2009

(54) Self-Activated Secure Identification Document

(76) Inventor: VICTOR MANUEL CELORIO, Gainesville, FL (US)

Correspondence Address: VICTOR CELORIO, 12300 NW 56TH AVE, GAINESVILLE, FL, 32653, US

(21) Appl. No.: 12/164,081

(22) Filed: Jun. 29, 2008

(51) Int. Cl. G08B 29/00

(52) U.S. Cl. 340/5.82

(57) ABSTRACT

The present invention describes a self activated biometrics identification device, which becomes active only when the biometrics of the bearer of the card matches the biometric data embedded in the card. Upon touching the card with a finger, the card scans the fingerprint of the user and analyzes the DNA from his or her epidermis to match it with the information encoded and embedded in the card itself. If the match is positive, the card becomes active and can be used for identification purposes, or make transactions with complete security.

### BACKGROUND OF THE INVENTION

This method and device describes the means for a secure and non falsifiable Self-Activated Identification device with means to tie the physical persona with the data on the ID device, that can be used as credit card, driving license, voting card, passport or any other type of document which requires a safe and highly secure means to identify the bearer of the ID device, either to allow him access access to protected areas, or to grant and limit the bearer permission to enter a country, or to perform commercial and banking transactions by using a device more secure than those in existence at the present time.

Historically, identification devices have incorporated means to identify the user either passively, via a photo attached to the ID device, or actively via communication means that connect to a remote centralized storage means in which the information of the owner of the ID device is kept for verification purposes. To use it in the second form, the owner of the ID device has to connect the card to a remotely located database for comparison and verification purposes. This creates huge security problems due to the fact that said database is stored at the remote location and therefore may be compromised, stolen or falsified. It also creates problems of miscommunication, logging jams, failed data access, and many others.

Besides those problems, the two-prong approach creates a situation where, by the single act of either stealing the ID device or by compromising the database, the falsification or misuse of such documents may be accomplished rather easily since there are no means to tie the physical persona with the data on the ID device. It suffices to steal a ID device and the passwords to be able to use it. That is why there are so many cases of identities being stolen and many millions of dollars lost every year around the world.

The present invention describes a device which is standalone and self-activated via the biometric data of the owner. The device's integrated biometric data is in encrypted format and in the OFF position, therefore inaccessible, until the owner presses his or her finger on a special area of the ID device that contains a sensor capable of sampling and reading the biometric data immediately.

According to the present invention when the owner of the device applies pressure with a finger, for example, the internal microprocessing devices (CPU) of the ID device process the information on the spot and make an immediate sampling and comparison between the biometric data etched on the ID device in encrypted format and the biometric data of the bearer of the ID device. If the biometric data is a match then the digital software will activate the ID device to the ON position for a limited length of time. If the match is negative, the ID device remains inactive and in the OFF position and therefore unusable and unfalsifiable.

This invention will prove advantageous because it avoids the usual problems derived from the misuse of the physical ID device, and/or the compromising of the databases remotely located to which many people have access. If somebody were to steal the ID device of the present invention, for example, the ID device itself could not be activated without a biometric data match. Therefore it would be useless. And the databases cannot be compromised because all of the biometric information is stored in the ID device itself and accessible only by activating the ID device itself.

This invention will prove specially advantageous in countries at war or in time of emergencies, or in countries where the communication networks are at a premium since the ID device is standalone and it doesn't depend on any external source to work.

The present invention comprises a more reliable and efficient means to secure the identity of the owner than earlier devices and methods.

### SUMMARY OF THE INVENTION

The present invention describes a self activated biometrics identification device, which becomes active only when the biometrics of the bearer of the card matches the biometric data embedded in the card.

### DESCRIPTION OF THE DRAWINGS

The present invention will be clearly understood by the detailed explanation found herewith, along with the drawings provided.

FIG. 1. Is a drawing of the preferred embodiment of an ID device (1), with a views of the front and the back of the card in the OFF position.

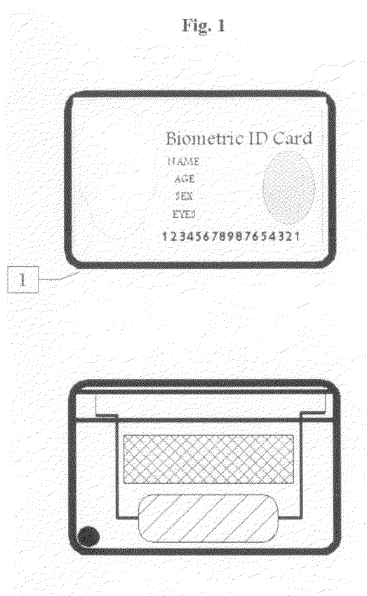

FIG. 2. Is a drawing of some of the elements incorporated into the ID device, a microprocessing device (2), a storage device (3), a battery (4), and a traditional magnetic strip (5).

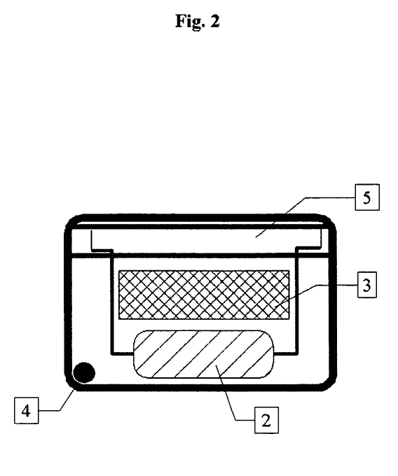

FIG. 3. Is a drawing some of the biometric elements which would be captured and stored within the card itself in the form of data, such as fingerprint (6), DNA profile (7), and a photograph of the subject (8).

FIG. 4. A sample drawing of the electronic circuit (9) which turns the ID device ON and OFF when the sensor (10) is pressed and a microprocessing device (2) matches the information found in the storage device (3).

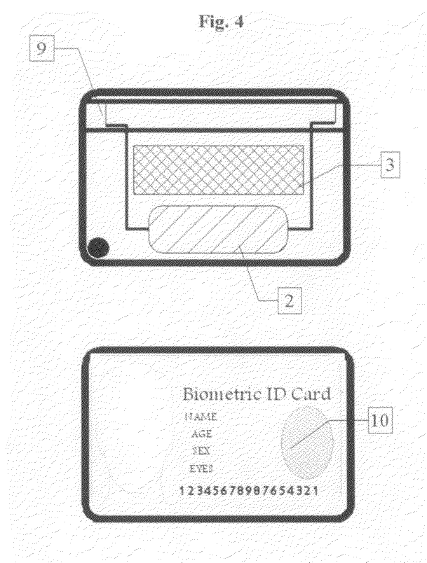

FIG. 5. A sample drawing of the activity triggered by pressing on the sensor (10) of the card, which sends the signal to the microprocessor (2) to make a match between the biometrics of the bearer, with the information kept on the storage device (3).

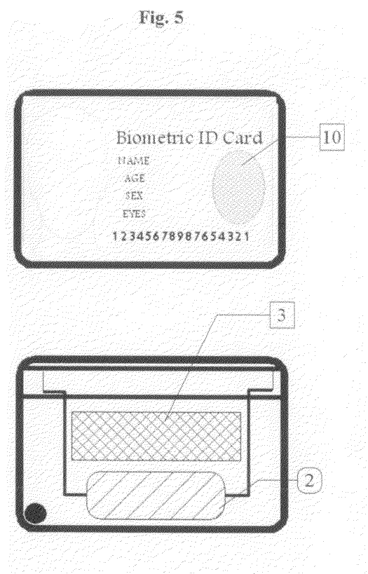

FIG. 6. A drawing of the ID device as it switches from an OFF (11) condition to an ON condition (12) to reveal all the information concealed. Includes an image projection means (13), that projects and shows the photo of the bearer, the name and personal information, and other biometric data (14).

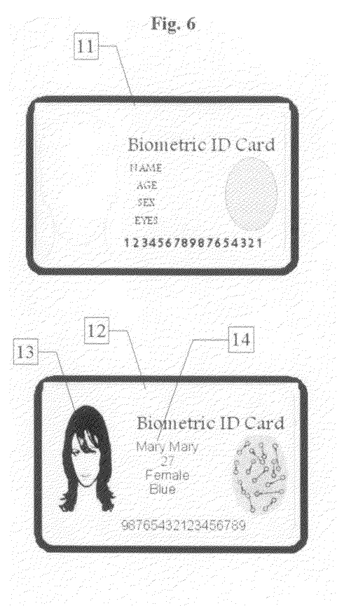

### DESCRIPTION OF THE INVENTION

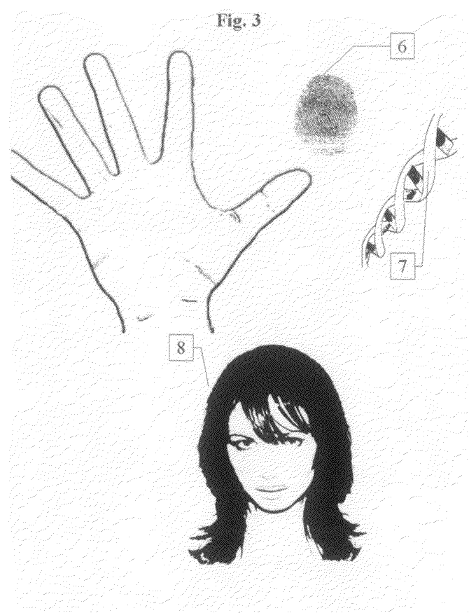

1. An ID device (1) with at least one storage means (3) to store digital information of the biometric data of the owner, which can be permanently attached or embedded on the Identification device itself. Said information will be used as a key to activate the device. The device will be in OFF position by default.
2. The ID device (1) will also contain in encrypted form traditional information required by the Issuer of the document, such as name of the company, address, account numbers, passwords, etcetera, (5).
3. Said storage means (3) is connected to an microprocessing device means (2) and also to a sensor means embedded in the ID device (10). Those means will work together to exchange and compare the data kept in the storage means (3) with the biometric data detected by the sensor on the spot.
4. The microprocessing device (2) will control a digital switch (9) which will act as a trigger for the circuit to be completed only when the biometric data comparison is a match, and will force the device to be turned ON.
5. The device comprises means to provide electric power to the microprocessing device. These means may be, for example, a small battery placed alongside the grid. (4)
6. Means for the issuer of the ID device to acquire a blueprint of the biometric data from the device user (FIG. 3), such as a fingerprint (6), a DNA strand (7), and a photography of the bearer (8).
7. Means for the issuer to make a digital record of said biometric data and hardwire it into the microprocessing device of the card. (2)
8. Means for the issuer to include and store said record of the biometric data in the storage and processing means (3) which is embedded in the ID device.
9. Said storage means will be connected to an internal device which will control if ID device is ON or OFF. (9)
10. A section of the ID device will be covered with an overlay of sensor material that will allow the biometric data of the owner to be sampled analyzed and compared. (10)
11. When the owner touches on the sensor material overlay with his or her skin, the ID device instantly collects a biological sampling of the skin, and scans the friction ridges of the finger.
12. The software of the microprocessor embedded in the ID device (2) then compares the biometric data to the digital information etched in the storage means of the ID device. (3)
13. If the information etched in the storage means of the ID device matches the information detected by the sensor overlay, then it will close the circuit of the switch in the microprocessor (9) and thus activate the ID device (11) and change it from the OFF position to the ON position (12). Otherwise the ID device will remain in the OFF position (14).
14. If activated, the ID device would then be readable and usable and could be used as usual as an Identification Card, either to enter a restricted space, to open locks, for a normal financial transaction, or any other purpose.
15. Additionally, the software could also activate other possible elements of the ID device, such as a small screen on the ID device so as to show a digital image of the owner of the ID device. (13) and personal data (14)
16. A true identification of the owner of the ID device would be thus secured in several levels,
   a. DNA blueprint
   b. One of ten fingerprints,
   c. Photo of the owner,
   d. Retinal grid,
   making it thus impossible to duplicate or to be compromised since only the true owner of the ID device with the correct biometric data code would be able to activate the ID device itself
17. Once it activates the ID device, the software turns on an internal timer. After the specified time elapses the code deactivates automatically the ID device again—move it to the OFF position.

This method and device will prove specially advantageous agencies where a highly secure ID is required, such as in passports, where the identification of the owner is crucial to combat terrorists activities.

It will prove advantageous also to credit card companies, banks, and other type of institutions and companies which have a urgent need to issue non falsifiable means of identification.

The present invention will prove advantageous also because the biometric data activation doesn't require ANY modification to the authorization networks already in place, since it is an independent and standalone device that can be implemented in existing devices. It requires only the modification of new documents issued to access the network. If a new self-activating ID device according to the present invention is lost or stolen, it will be useless.

The amount of memory required for the ID device to store the fingertip information, DNA code and the software code required by the sensors to read the information, to make the match and to activate the document, is minimal since it needs to compare only one set of data, versus the millions of DNA profiles or fingerprints stored in a centralized database. Also, because it needs to match only one set of data, and accept it or reject it, the operation is immediate and highly secure.

This method and device will prove equally advantageous to any other institution which require a secure identification of the user.

The benefits and preferred embodiments hereby described are not meant to be as limiting descriptions, but as an non-exclusionary examples.

### PRIOR ART

All of the Prior Art found up to this date relies on the external storage of data, either for identification or for corroboration. The problem with this approach is that said data may be compromised (damaged, corrupted or stolen) by third parties.

### EXAMPLES

U.S. Pat. No. 4,993,068 to Gerald V. Piosenka, et al, describes a personal identification system for identifying users at remote access control sites. The card relies on the data stored on the reader.

U.S. Pat. No. 5,180,902 to David Schick, et al. shows a Self verifying transaction card with disabling capability. However, said device relies on the user typing into the card a set of numbers (PIN).

U.S. Pat. No. 5,193,114 to Donald R. Moseley, et al, shows a method of authentication techniques, that relies on the user typing an identification code on a plurality of electric switches.

U.S. Pat. No. 5,534,857 to Simon G. Laing, et al, describes a method for secure identification via remote terminals.

U.S. Pat. No. 5,869,822 to Dexter L. Meadows, II, et all,

U.S. Pat. No. 6,816,058 to MacGregor, et al. shows a device with a biometric device integrated into the credit card or debit card. However, the method proposed in that patent again relies on the use of a network to make the identification and match of the information. Thus, it requires a large database of information stored independently, which may be compromised.

This is a disadvantage that is avoided by the present method and device, since the information is always secured and individually stored within the document, and said document will be activated on the spot by the user, saving time, and energy.

U.S. Pat. No. 7,325,724 to David S. Bonalle, et all, shows a method in which biometric data is used to allow transactions with a credit card. However, this method also has the disadvantage of requiring a separate reader to read the information, and again to communicate with a central server where the data of the user is stored.

### More Prior Art in the Following Pages

| | Patent Number | Title | Issue date |
|---|---|---|---|
| 1 | 4453074 | Protection system for intelligent cards | Jun. 05, 1984 |
| 2 | 4582985 | Data carrier | Apr. 15, 1986 |
| 3 | 4725719 | Restricted purpose, commercial, monetary regulation method | Feb. 16, 1988 |
| 4 | 4747147 | Fingerprint recognition and retrieval system | May 24, 1988 |
| 5 | 4910521 | Dual band communication receiver | Mar. 20, 1990 |
| 6 | 4993068993068 | Unforgeable personal identification system | Feb. 12, 1991 |
| 7 | 5175416 | Funds transfer system | Dec. 29, 1992 |
| 8 | 5180902 | Self verifying transaction card with disabling capability | Jan. 19, 1993 |
| 9 | 5193114 | Consumer oriented smart card system and authentication techniques | Mar. 09, 1993 |
| 10 | 5245329 | Access control system with mechanical keys which store data | Sep. 14, 1993 |
| 11 | 5259649 | Credit card | Nov. 09, 1993 |
| 12 | 5321751 | Method and apparatus for credit card verification | Jun. 14, 1994 |
| 13 | 5438184 | Method and apparatus for electronic cash transactions | Aug. 01, 1995 |
| 14 | 5461217 | Secure money transfer techniques using smart cards | Oct. 24, 1995 |
| 15 | 5513272 | System for verifying use of a credit/identification card | Apr. 30, 1996 |
| 16 | 5521966 | Method and system for mediating transactions that use portable smart cards | May 28, 1996 |
| 17 | 5534857 | Method and system for secure, decentralized personalization of smart cards | Jul. 09, 1996 |
| 18 | 5539825 | Electronic cashless transaction system | Jul. 23, 1996 |
| 19 | 5559504 | Surface shape sensor, identification device using this sensor | Sep. 24, 1996 |
| 20 | 5559887 | Collection of value from stored value systems | Sep. 24, 1996 |
| 21 | 5577121 | Transaction system for integrated circuit cards | Nov. 19, 1996 |
| 22 | 5578808 | Data card that can be used for transactions involving separate card issuers | Nov. 26, 1996 |
| 23 | 5581630 | Personal identification | Dec. 03, 1996 |
| 24 | 5590038 | Universal electronic transaction card including receipt storage | Dec. 31, 1996 |
| 25 | 5590197 | Electronic payment system and method | Dec. 31, 1996 |
| 26 | 5602918 | Application level security system and method | Feb. 11, 1997 |
| 27 | 5604801 | Public key data communications system under control | Feb. 18, 1997 |
| 28 | 5613001 | Digital signature verification technology for smart credit card | Mar. 18, 1997 |
| 29 | 5677953 | System and method for access control for portable data storage media | Oct. 14, 1997 |
| 30 | 5721781 | Authentication system and method for smart card transactions | Feb. 24, 1998 |
| 31 | 5737439 | Anti-fraud biometric scanner that accurately detects blood flow | Apr. 07, 1998 |
| 32 | 5739512 | Digital delivery of receipts | Apr. 14, 1998 |
| 33 | 5742756 | System and method of using smart cards to perform security | Apr. 21, 1998 |
| 34 | 5742845 | System for extending present open network communication protocols | Apr. 21, 1998 |
| 35 | 5757917 | Computerized payment system for purchasing goods | May 26, 1998 |
| 36 | 5764789 | Tokenless biometric ATM access system | Jun. 09, 1998 |
| 37 | 5778173 | Mechanism for enabling secure electronic transactions on the open internet | Jul. 07, 1998 |
| 38 | 5796831 | Method for conducting a transaction between a chip card | Aug. 18, 1998 |
| 39 | 5799087 | Electronic-monetary system | Aug. 25, 1998 |
| 40 | 5806045 | Method and system for allocating and redeeming incentive credits | Sep. 08, 1998 |
| 41 | 5815252 | Biometric identification process and system utilizing multiple parameters | Sep. 29, 1998 |
| 42 | 5815657 | System, method and article of manufacture for network electronic authorization | Sep. 29, 1998 |
| 43 | 5826241 | Computerized system for making payments and authenticating transactions | Oct. 20, 1998 |
| 44 | 5826243 | Integrated system for controlling master account and nested subaccount(s) | Oct. 20, 1998 |
| 45 | 5835894 | Speaker and command verification method | Nov. 10, 1998 |
| 46 | 5838818 | Artifact reduction compression method and apparatus for mosaiced images | Nov. 17, 1998 |
| 47 | 5857079 | Smart card for automatic financial records | Jan. 05, 1999 |
| 48 | 5869822 | Automated fingerprint identification system | Feb. 09, 1999 |
| 49 | 5875432 | Computerized voting information system having predefined content | Feb. 23, 1999 |
| 50 | 5884271 | Device, system and methods of conducting paperless transactions | Mar. 16, 1999 |
| 51 | 5884292 | System for smart card funds refill | Mar. 16, 1999 |
| 52 | 5889941 | System and apparatus for smart card personalization | Mar. 30, 1999 |
| 53 | 5892211 | Transaction system comprising a first transportable integrated circuit device | Apr. 06, 1999 |
| 54 | 5898838 | Editor for developing statements to support i/o operation on open network | Apr. 27, 1999 |
| 55 | 5901239 | Skin pattern and fingerprint classification system | May 04, 1999 |
| 56 | 5905908 | Open network system for I/O operations with non-standard I/O devices | May 18, 1999 |
| 57 | 5907620 | Method and apparatus for enforcing the use of cryptography | May 25, 1999 |
| 58 | 5912446 | Card reader with carriage powered by movement of inserted card | Jun. 15, 1999 |
| 59 | 5915973 | System for administration of remotely-proctored, secure examinations | Jun. 29, 1999 |
| 60 | 5917913 | Portable electronic authorization devices and methods therefor | Jun. 29, 1999 |
| 61 | 5917925 | System for dispensing, verifying and tracking postage and other information | Jun. 29, 1999 |
| 62 | 5920058 | Holographic labeling and reading machine for authentication and security | Jul. 06, 1999 |
| 63 | 5920629 | Electronic-monetary system | Jul. 06, 1999 |
| 64 | 5920847 | Electronic bill pay system | Jul. 06, 1999 |
| 65 | 5930767 | Transaction methods systems and devices | Jul. 27, 1999 |
| 66 | 5931917 | System, method and article of manufacture for a gateway system architecture | Aug. 03, 1999 |
| 67 | 5936226 | Mass storage device adapter for smart cards | Aug. 10, 1999 |
| 68 | 5942761 | Enhancement methods and devices for reading a fingerprint image | Aug. 24, 1999 |
| 69 | 5987155 | Biometric input device with peripheral port | Nov. 16, 1999 |
| 70 | 5988497 | Method for authenticating credit transactions to prevent fraudulent charges | Nov. 23, 1999 |
| 71 | 5995014 | Biometric interface device for upgrading existing access control units | Nov. 30, 1999 |
| 72 | 6012039 | Tokenless biometric electronic rewards system | Jan. 04, 2000 |
| 73 | 6012636 | Multiple card data system having first and second memory elements | Jan. 11, 2000 |
| 74 | 6016476 | Portable information and transaction processing system and method | Jan. 18, 2000 |
| 75 | 6018739 | Biometric personnel identification system | Jan. 25, 2000 |
| 76 | 6041410 | Personal identification fob | Mar. 21, 2000 |
| 77 | 6047281 | Method and apparatus for expandable biometric searching | Apr. 04, 2000 |
| 78 | 6047282 | Apparatus and method for expandable biometric searching | Apr. 04, 2000 |
| 79 | 6060815 | Frequency mixing passive transponder | May 09, 2000 |
| 80 | 6070159 | Method and apparatus for expandable biometric searching | May 30, 2000 |
| 81 | 6091835 | Method and system for transcribing electronic affirmations | Jul. 18, 2000 |
| 82 | 6095413 | System and method for enhanced fraud detection in automated electronic credit card | Aug. 01, 2000 |
| 83 | 6101477 | Methods and apparatus for a travel-related multi-function smartcard | Aug. 08, 2000 |
| 84 | 6104311 | Information storage and identification tag | Aug. 15, 2000 |
| 85 | 6104922 | User authentication in a communication system utilizing biometric information | Aug. 15, 2000 |
| 86 | 6116736 | Pupilometer with pupil irregularity detection capability | Sep. 12, 2000 |
| 87 | 6120461 | Apparatus for tracking the human eye with a retinal scanning display, and method thereof | Sep. 19, 2000 |
| 88 | 6130623 | Encryption for modulated backscatter systems | Oct. 10, 2000 |
| 89 | 6148093 | Methods and device for validating a personal signature | Nov. 14, 2000 |
| 90 | 6154879 | Tokenless biometric ATM access system | Nov. 28, 2000 |
| 91 | 6175656 | Non-linear video sharpening filter | Jan. 16, 2001 |
| 92 | 6199079 | Method and system for automatically filling forms in an integrated network based | Mar. 06, 2001 |
| 93 | 6199762 | Methods and apparatus for dynamic smartcard synchronization and personalization | Mar. 13, 2001 |
| 94 | 6219639 | Method and apparatus for recognizing identity of individuals | Apr. 17, 2001 |
| 95 | 6223984 | Distinct smart card reader having wiegand, magnetic strip and bar code | May 01, 2001 |
| 96 | 6233348 | Fingerprint registering apparatus, fingerprint identifying apparatus | May 15, 2001 |
| 97 | 6257486 | Smart card pin system, card, and reader | Jul. 10, 2001 |
| 98 | 6257620 | High efficiency ski for sailing on snow or ice | Jul. 10, 2001 |
| 99 | 6263446 | Method and apparatus for secure distribution of authentication credentials | Jul. 17, 2001 |
| 100 | 6265977 | Radio frequency identification tag apparatus and related method | Jul. 24, 2001 |
| 101 | 6268788 | Apparatus and method for providing an authentication system based on biometrics | Jul. 31, 2001 |
| 102 | 6269348 | Tokenless biometric electronic debit and credit transactions | Jul. 31, 2001 |
| 103 | 6270011 | Remote credit card authentication system | Aug. 07, 2001 |
| 104 | 6272562 | Access control unit interface | Aug. 07, 2001 |
| 105 | 6298146 | Instruction and/or identification input unit | Oct. 02, 2001 |
| 106 | 6307956 | Writing implement for identity verification system | Oct. 23, 2001 |
| 107 | 6325285 | Smart card with integrated fingerprint reader | Dec. 04, 2001 |
| 108 | 6327578 | Four-party credit/debit payment protocol | Dec. 04, 2001 |
| 109 | 6332193 | Method and apparatus for securely transmitting and authenticating biometric data | Dec. 18, 2001 |
| 110 | 6338048 | Electronic transaction system | Jan. 08, 2002 |
| 111 | 6345761 | Method and device for processing biometric data | Feb. 12, 2002 |
| 112 | 6357663 | Fingerprint identifying PC card | Mar. 19, 2002 |
| 113 | 6360953 | Secure print sensing smart card with on-the-fly-operation | Mar. 26, 2002 |
| 114 | 6424249 | Positive identity verification system and method including biometric user authentication | Jul. 23, 2002 |
| 115 | 6446862 | Point of purchase (PoP) terminal | Sep. 10, 2002 |
| 116 | 6480825 | System and method for detecting a recorded voice | Nov. 12, 2002 |
| 117 | 6483929 | Method and apparatus for histological and physiological biometric operation | Nov. 19, 2002 |
| 118 | 6483932 | Method and apparatus for rolled fingerprint capture | Nov. 19, 2002 |
| 119 | 6490443 | Communication and proximity authorization systems | Dec. 03, 2002 |
| 121 | 6496594 | Method and apparatus for aligning and comparing images of the face and body | Dec. 17, 2002 |
| 122 | 6507662 | Method and system for biometric recognition based on electric and/or magnetic | Jan. 14, 2003 |
| 123 | 6519565 | Method of comparing utterances for security control | Feb. 11, 2003 |
| 124 | 6539101 | Method for identity verification | Mar. 25, 2003 |
| 125 | 6560581 | System and method for secure electronic commerce transaction | May 06, 2003 |
| 126 | 6588660 | Passive contactless smartcard security system | Jul. 08, 2003 |
| 127 | 6588673 | Method and system providing in-line pre-production data preparation | Jul. 08, 2003 |
| 128 | 6591249 | Touch scan internet credit card verification purchase process | Jul. 08, 2003 |
| 129 | 6591249 | Touch scan internet credit card verification purchase process | Jul. 08, 2003 |
| 130 | 6601759 | System and method for providing feedback in an interactive payment system | Aug. 05, 2003 |
| 131 | 6601759 | System and method for providing feedback in an interactive payment system | Aug. 05, 2003 |
| 132 | 6601762 | Point-of-sale (POS) voice authentication transaction system | Aug. 05, 2003 |
| 133 | 6609656 | Method and system for identifying lost or stolen devices | Aug. 26, 2003 |
| 134 | 6615191 | Software licensing and distribution systems and methods employing biometric | Sep. 02, 2003 |
| 135 | 6628813 | Individualized fingerprint scanner | Sep. 30, 2003 |
| 136 | 6629591 | Smart token | Oct. 07, 2003 |
| 137 | 6631201 | Relief object sensor adaptor | Oct. 07, 2003 |
| 138 | 6636620 | Personal identification authenticating with fingerprint identification | Oct. 21, 2003 |
| 139 | 6655585 | System and method of biometric smart card user authentication | Dec. 02, 2003 |
| 140 | 6657614 | Detecting apparatus, input apparatus, pointing device, individual identification | Dec. 02, 2003 |
| 141 | 6658164 | Calibration and correction in a fingerprint scanner | Dec. 02, 2003 |
| 142 | 6662166 | Tokenless biometric electronic debit and credit transactions | Dec. 09, 2003 |
| 143 | 6669086 | Self service check cashing system and method | Dec. 30, 2003 |
| 144 | 6681328 | System and method for global internet digital identification | Jan. 20, 2004 |
| 145 | 6687391 | Adjustable, rotatable finger guide in a tenprint scanner with movable prism platen | Feb. 03, 2004 |
| 146 | 6697947 | Biometric based multi-party authentication | Feb. 24, 2004 |
| 147 | 6703918 | Portable information equipment, authentication device, authentication system | Mar. 09, 2004 |
| 148 | 6719200 | Checking of right to access | Apr. 13, 2004 |
| 149 | 6732919 | System and method for using a multiple-use credit card | May 11, 2004 |
| 150 | 6734887 | Process for printing a metallic security feature on identification cards | May 11, 2004 |
| 151 | 6744909 | Authentication system and method | Jun. 01, 2004 |
| 152 | 6744910 | Hand-held fingerprint scanner with on-board image normalization data storage | Jun. 01, 2004 |
| 153 | 6765470 | Mobile electronic apparatus having function of verifying a user by biometrics | Jul. 20, 2004 |
| 154 | 6776332 | System and method for validating and operating an access card | Aug. 17, 2004 |
| 155 | 6799726 | Authorization control device including a wristwatch having a biometric sensor | Oct. 05, 2004 |
| 156 | 6816058 | Bio-metric smart card, bio-metric smart card reader and method of use | Nov. 09, 2004 |
| 157 | 6819219 | Method for biometric-based authentication in wireless communication | Nov. 16, 2004 |
| 158 | 6826000 | Optical fingerprint acquisition apparatus | Nov. 30, 2004 |
| 159 | 6828299 | Polyhydroxy glycopeptide derivatives | Dec. 07, 2004 |
| 160 | 6828960 | Electronic writing instrument with fingerprint scanner | Dec. 07, 2004 |
| 161 | 6834795 | Secure user authentication to computing resource via smart card | Dec. 28, 2004 |
| 162 | 6867850 | Light wedge for illuminating a platen in a print scanner | Mar. 15, 2005 |
| 163 | 6870946 | Compact optical fingerprint capturing and recognition system | Mar. 22, 2005 |
| 164 | 6873974 | System and method for use of distributed electronic wallets | Mar. 29, 2005 |
| 165 | 6877097 | Security access method and apparatus | Apr. 05, 2005 |
| 166 | 6886104 | Rechargeable mobile hand-held fingerprint scanner with a data and power | Apr. 26, 2005 |
| 167 | 6892940 | Encryption process employing chaotic maps and digital signature process | May 17, 2005 |
| 168 | 6901154 | Method of detecting authorised biometric information sensor | May 31, 2005 |
| 169 | 6914517 | Fingerprint sensor with feature authentication | Jul. 05, 2005 |
| 170 | 6917695 | High contrast, low distortion optical acquisition system for image capturing | Jul. 12, 2005 |
| 171 | 6925439 | Device, system and methods of conducting paperless transactions | Aug. 02, 2005 |
| 172 | 6925565 | Pen-based transponder identity verification system | Aug. 02, 2005 |
| 173 | 6928181 | Method and system for biometric recognition using unique internal distinguishing | Aug. 09, 2005 |
| 174 | 6928195 | Palm scanner using a programmable nutating mirror for increased resolution | Aug. 09, 2005 |
| 175 | 6929413 | Printer driver log security verification for identification cards | Aug. 16, 2005 |
| 176 | 6931538 | Portable personal authentication apparatus and electronic system | Aug. 16, 2005 |
| 177 | 6934861 | National identification card system and biometric identity verification method | Aug. 23, 2005 |
| 178 | 6934861 | National identification card system and biometric identity verification method | Aug. 23, 2005 |
| 180 | 6944768 | System and methods for access control utilizing two factors to control access | Sep. 13, 2005 |
| 181 | 6944768 | System and methods for access control utilizing two factors to control access | Sep. 13, 2005 |
| 182 | 6954260 | Systems and methods for illuminating a platen in a print scanner | Oct. 11, 2005 |
| 183 | 6970582 | Method and system for identity verification using multiple simultaneously scanned biometric | Nov. 29, 2005 |
| 184 | 6971031 | National identification card system and biometric identity verification method | Nov. 29, 2005 |
| 185 | 6983062 | Fingerprint scanner auto-capture system and method | Jan. 03, 2006 |
| 186 | 6988665 | Grayscale security microprinting for identification cards | Jan. 24, 2006 |
| 187 | 6996259 | System and method for counting ridges in a captured print image | Feb. 07, 2006 |
| 188 | 7010148 | Calibration and correction in a fingerprint scanner | Mar. 07, 2006 |
| 189 | 7049962 | Materials and construction for a tamper indicating radio frequency identification label | May 23, 2006 |
| 190 | 7051925 | System and method for funding a collective account by use of an electronic tag | May 30, 2006 |
| 191 | 7059159 | Security system for cargo trailers | Jun. 13, 2006 |
| 192 | 7059531 | Method and system for smellprint recognition biometrics on a fob | Jun. 13, 2006 |
| 193 | 7068822 | System and method for sending a packet with position address and line scan data | Jun. 27, 2006 |
| 194 | 7073711 | Mobile handheld code reader and print scanner system and method | Jul. 11, 2006 |
| 195 | 7079007 | Systems and methods utilizing biometric data | Jul. 18, 2006 |
| 196 | 7095880 | Method and apparatus for rolled fingerprint capture | Aug. 22, 2006 |
| 197 | 7102523 | Radio frequency identification tag antenna configurations | Sep. 05, 2006 |
| 198 | 7103201 | Methods for capturing fingerprint images using a moving platen | Sep. 05, 2006 |
| 199 | 7127088 | Method of authenticating proper access to secured site and device for implementation thereof | Oct. 24, 2006 |
| 200 | 7132946 | Variable frequency radio frequency identification (RFID) tags | Nov. 07, 2006 |
| 201 | 7155039 | Automatic fingerprint identification system and method | Dec. 26, 2006 |
| 202 | 7162060 | Method, system, and computer program product for control of platen movement | Jan. 09, 2007 |
| 203 | 7164440 | Dynamic image adaptation method for adjusting the quality of digital prints | Jan. 16, 2007 |
| 204 | 7165716 | Method, device and system for biometrically authenticating a person | Jan. 23, 2007 |
| 205 | 7171662 | System and method for software licensing | Jan. 30, 2007 |
| 206 | 7181017 | System and method for secure three-party communications | Feb. 20, 2007 |
| 207 | 7203344 | Biometric imaging system and method | Apr. 10, 2007 |
| 208 | 7239227 | Command interface using fingerprint sensor input system | Jul. 03, 2007 |
| 209 | 7271881 | Systems and methods for illuminating a platen in a print scanner | Sep. 18, 2007 |
| 210 | 7289649 | Fingerprint imager | Oct. 30, 2007 |
| 211 | 7303120 | System for biometric security using a FOB | Dec. 04, 2007 |
| 212 | 7308122 | Biometric imaging system and method | Dec. 11, 2007 |
| 213 | 7314164 | System for biometric security using a smartcard | Jan. 01, 2008 |
| 214 | 7314165 | Method and system for smellprint recognition biometrics on a smartcard | Jan. 01, 2008 |
| 215 | 7319565 | Silicone rubber surfaces for biometric print TIR prisms | Jan. 15, 2008 |
| 216 | 7325724 | Method for registering a biometric for use with a smartcard | |
| 217 | H2120 | BIOMETRIC PERSONAL IDENTIFICATION CREDENTIAL SYSTEM (PICS) | (unknown) |
| | | STATEMENT OF GOVERNMENT INTEREST | |
| 218 | RE36580 | System for verifying use of credit/identification card including recording physical attributes of | Feb. 22, 2000 |
| | | unauthorized users | |

What is claimed is:

1. The method of an ID device using biometric data stored in the ID device to activate the ID device itself.

2. The method by which said ID device comprises at least one means of a biometric sensor, at least one means of storage of digital data (memory chip), at least one means of an microprocessing device (CPU) and at least one means of software capable of controlling the process of scanning, collecting, and comparing data.

3. The method of an ID device that comprises at least one means to store biometric data, at least one means by which the stored biometric data is compared with the sample provided on the spot by the bearer, and at least one means of activating the ID device in case the match is positive.
